(19) United States
(12) Patent Application Publication
(10) Pub. No.: US 2026/0343346 A1
(43) Pub. Date: Oct. 29, 2026

(54) METHOD AND APPARATUS FOR CELL SELECTION AND CELL RESELECTION IN NON-TERRESTRIAL NETWORK (NTN)

(71) Applicant: Samsung Electronics Co., Ltd., Gyeonggi-do (KR)

(72) Inventors: Aby Kanneath ABRAHAM, Bangalore (IN); Chadi KHIRALLAH, Bangalore (IN)

(21) Appl. No.: 18/998,889

(22) PCT Filed: Aug. 1, 2023
(86) PCT No.: PCT/KR2023/011188

§ 371 Date: Jan. 27, 2025

(30) Foreign Application Priority Data
Aug. 1, 2022 (IN) 202241044016
Jul. 13, 2023 (IN) 202241044016

(51) Int. Cl. H04W 36/00; H04W 84/06

(52) U.S. Cl. CPC H04W 36/0085; H04W 36/00835; H04W 84/06

(57) ABSTRACT

The disclosure relates to a 5G or 6G communication system for supporting a higher data transmission rate. The disclosure provides a method and apparatus for cell selection and cell reselection in non-terrestrial network (NTN). Embodiments herein provide a method for handling a cell selection and cell reselection in a non-terrestrial network (NTN) (1000) by a UE (500). The method includes receiving a service time, a t-service for a serving cell and a cell reselection timer for a neighbouring frequency broadcasted by a network apparatus (200). Further, method includes triggering to perform a cell reselection measurement at least a duration of the cell reselection timer before the t-service for the neighbouring frequency or at least before an absolute value of a t-service-applicable cell reselection timer irrespective of a predefined criteria. Alternatively, the method includes performing a cell reselection measurement at least for an applicable cell reselection timer duration before stopping the t-service. The method can be used to handle the cell selection and the cell reselection in the NTN without wasting the resource and time effective manner.

### TECHNICAL FIELD

The present invention relates to a wireless communication, and more specifically related to a method and a User Equipment (UE) for cell selection and cell reselection in a NonTerrestrial Network (NTN) network.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Technical Problem

The principal object of the embodiments herein is to provide a method and a UE for handling a cell selection and a cell reselection in a NTN.

Another object of the embodiments herein is to handle an interaction of a service time, a t-service of quasi-earth fixed cells and earth-moving cells with a cell reselection timer in the NTN, so as to handle the cell selection and the cell reselection in the NTN without wasting the resource and time effective manner.

Another object of the embodiments herein is to handle the feeder link switch in the NTN.

The present invention has been made to address at least the above problems and/or disadvantages and to provide at least the advantages described below. Accordingly, for more enhanced communication system, there is a need for method and apparatus for conditional PSCell addition and change.

### Solution to Problem

Accordingly the embodiment herein is to provide a method for handling a cell selection and cell reselection in a NTN. The method includes receiving, by a UE, a service time, a t-service for a serving cell and a cell reselection timer for a neighbouring frequency broadcasted by a network apparatus. Further, method includes triggering to perform a cell reselection measurement at least a duration of the cell reselection timer before the t-service for the neighbouring frequency or at least before an absolute value of a t-service-applicable cell reselection timer irrespective of a predefined criteria. Alternatively, the method includes performing a cell reselection measurement at least for an applicable cell reselection timer duration before stopping the t-service.

In an embodiment, the predefined criteria includes at least one of: distance between the UE and a reference location of the serving cell, a Srxlev greater than a SIntraSearchP, a Squal greater than a SIntraSearchQ, a Srxlev greater than a SnonIntraSearchP and a Squal greater than a SnonIntraSearchQ.

In an embodiment, the cell reselection timer is broadcasted in a system information for a frequency or a RAT.

In an embodiment, the t-service includes a t-service-feeder switch, the time the cell stops service due to the t-service-feeder switch and the UE performs at least one of: perform measurements before the t-service-feeder switch irrespective of the cell reselection timer and perform measurement considering the applicable cell reselection timer along with the t-service.

In an embodiment, the method includes determining, by the UE, that a cell reselection criteria is satisfied after a feeder link switch is completed. Further, the method includes reselecting, by the UE, back to a same servicing cell from which the UE has moved due to the feeder link switch.

In an embodiment, the method includes determining, by the UE, that the UE has moved to camped on any cell state upon determining that the UE is not able to find a suitable cell after the cell has become unavailable due to a feeder switch or to a no service area after the cell has become unavailable due to a feeder switch. Further, the method includes performing, by the UE, a search in predefined interval to select the cell.

In an embodiment, the method includes receiving, by the UE, a timer information broadcasted by the network apparatus, wherein the timer information indicating a time in which the UE is expected to come back to a service after the t-service. Further, the method includes considering, by the UE, the cell as candidate for the cell reselection after the time when the UE is in any cell selection state or any cell state or no service state.

In an embodiment, the t-Service indicates a time information on when a cell provided via a network apparatus is going to stop serving the area in which the cell is currently covering the service.

In an embodiment, the cell reselection timer indicates the time interval during which the cell reselection criteria remains fulfilled for the UE to perform cell reselection.

In an embodiment, the method includes one of: ignoring, by the UE, applicable cell reselection timer, determining, by the UE, an applicable cell reselection timer to the duration to stop for the t-Service, and determining, by the UE, an applicable cell reselection timer to a value less than the duration to stop for the t-service, when the t-service is provided and the duration to stop for the t-Service is less than cell reselection timer.

Accordingly the embodiment herein is to provide a UE for handling a cell selection and cell reselection in a NTN. The UE includes a cell selection and reselection controller communicatively coupled to a memory and a processor. The cell selection and reselection controller is configured to receive a service time, a t-service for a serving cell and a cell reselection timer for a neighbouring frequency broadcasted by a network apparatus. Further, the cell selection and reselection controller is configured to trigger to perform a cell reselection measurement at least a duration of the cell reselection timer before the t-service for the neighbouring frequency or at least before an absolute value of a t-service-applicable cell reselection timer irrespective of a predefined criteria. Alternatively, the cell selection and reselection controller is configured to perform a cell reselection measurement at least for an applicable cell reselection timer duration before stopping the t-service.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### Advantageous Effects of Invention

Advantages, and salient features of the invention will become apparent to those skilled in the art from the following detailed description, which, taken in conjunction with the annexed drawings, discloses exemplary embodiments of the invention. Accordingly present invention, a cell selection and a cell reselection in a non-terrestrial network (NTN) can be performed efficiently.

### BRIEF DESCRIPTION OF DRAWINGS

The method, the UE and the NTN are illustrated in the accompanying drawings, throughout which like reference letters indicate corresponding parts in the various figures. The embodiments herein will be better understood from the following description with reference to the drawings, in which:

FIG. 1 illustrates a non-terrestrial network (NTN);

FIG. 2 illustrates a non-terrestrial network (NTN) for handling a cell selection and cell reselection, according to the embodiments as disclosed herein;

FIG. 3 shows various hardware components of a UE, according to the embodiments as disclosed herein;

FIG. 4 is a flow chart illustrating a method for handling a cell selection and cell reselection in the NTN, according to the embodiments as disclosed herein;

FIG. 5 is a flow chart illustrating a scenario of a method for handling of a T-service and a Treselection at the UE, according to the embodiments as disclosed herein;

FIG. 6 is another flow chart illustrating a scenario of a method for handling of the Tservice and the Treselection at the UE, according to the embodiments as disclosed herein;

FIG. 7 is another flow chart illustrating a scenario of a method for handling of the Tservice and the Treselection at the UE, according to the embodiments as disclosed herein; and

FIG. 8 is another flow chart illustrating a scenario of a method for handling of t-service-feederswitch at the UE, according to the embodiments as disclosed herein.

FIG. 9 illustrates the structure of the UE to which embodiments of the disclosure can be applied.

FIG. 10 illustrates a block diagram of a base station in a wireless communication system to which embodiments of the disclosure can be applied.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the one or more elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

### MODE FOR THE INVENTION

The following specification particularly describes and ascertains the nature of this invention and the manner in which it is to be performed:

Accordingly the embodiment herein is to provide a method for handling a cell selection and cell reselection in a NTN. The method includes receiving, by a UE, a service time, a t-service for a serving cell and a cell reselection timer for a neighbouring frequency broadcasted by a network apparatus. Further, method includes triggering to perform a cell reselection measurement at least a duration of the cell reselection timer before the t-service for the neighbouring frequency or at least before an absolute value of a t-service-applicable cell reselection timer irrespective of a predefined criteria. Alternatively, the method includes performing a cell reselection measurement at least for an applicable cell reselection timer duration before stopping the t-service.

In an embodiment, the predefined criteria includes at least one of: distance between the UE and a reference location of the serving cell, a Srxlev greater than a SIntraSearchP, a Squal greater than a SIntraSearchQ, a Srxlev greater than a SnonIntraSearchP and a Squal greater than a SnonIntraSearchQ.

In an embodiment, the cell reselection timer is broadcasted in a system information for a frequency or a RAT.

In an embodiment, the t-service includes a t-service-feeder switch, the time the cell stops service due to the t-service-feeder switch and the UE performs at least one of: perform measurements before the t-service-feeder switch irrespective of the cell reselection timer and perform measurement considering the applicable cell reselection timer along with the t-service.

In an embodiment, the method includes determining, by the UE, that a cell reselection criteria is satisfied after a feeder link switch is completed. Further, the method includes reselecting, by the UE, back to a same servicing cell from which the UE has moved due to the feeder link switch.

In an embodiment, the method includes determining, by the UE, that the UE has moved to camped on any cell state upon determining that the UE is not able to find a suitable cell after the cell has become unavailable due to a feeder switch or to a no service area after the cell has become unavailable due to a feeder switch. Further, the method includes performing, by the UE, a search in predefined interval to select the cell.

In an embodiment, the method includes receiving, by the UE, a timer information broadcasted by the network apparatus, wherein the timer information indicating a time in which the UE is expected to come back to a service after the t-service. Further, the method includes considering, by the UE, the cell as candidate for the cell reselection after the time when the UE is in any cell selection state or any cell state or no service state.

In an embodiment, the t-Service indicates a time information on when a cell provided via a network apparatus is going to stop serving the area in which the cell is currently covering the service.

In an embodiment, the cell reselection timer indicates the time interval during which the cell reselection criteria remains fulfilled for the UE to perform cell reselection.

In an embodiment, the method includes one of: ignoring, by the UE, applicable cell reselection timer, determining, by the UE, an applicable cell reselection timer to the duration to stop for the t-Service, and determining, by the UE, an applicable cell reselection timer to a value less than the duration to stop for the t-service, when the t-service is provided and the duration to stop for the t-Service is less than cell reselection timer.

Accordingly the embodiment herein is to provide a UE for handling a cell selection and cell reselection in a NTN. The UE includes a cell selection and reselection controller communicatively coupled to a memory and a processor. The cell selection and reselection controller is configured to receive a service time, a t-service for a serving cell and a cell reselection timer for a neighbouring frequency broadcasted by a network apparatus. Further, the cell selection and reselection controller is configured to trigger to perform a cell reselection measurement at least a duration of the cell reselection timer before the t-service for the neighbouring frequency or at least before an absolute value of a t-service-applicable cell reselection timer irrespective of a predefined criteria. Alternatively, the cell selection and reselection controller is configured to perform a cell reselection measurement at least for an applicable cell reselection timer duration before stopping the t-service.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

According to 3rd Generation Partnership Project (3GPP) specification technical specification (TS) 38.300, cell reselection is a process that identifies a cell that a User Equipment (UE) should camp on when the UE is in a non-connected state (i.e. radio resource control (RRC)_IDLE state and RRC_INACTIVE state). The cell reselection is based on a cell reselection criteria. Inter-frequency reselection is based on absolute priorities where the UE tries to camp on a highest priority frequency available. The cell reselection involves measurements of a serving cell and neighbour cells. The cell reselection can be speed dependent and in multi-beam operations, a cell quality is derived amongst the beams corresponding to the same cell.

Details of the cell reselection are provided in 3GPP specifications like TS 38.304. In an example, from TS 38.304 v17.1.0—Absolute priorities of different new radio (NR) frequencies or inter-RAT frequencies may be provided to the UE in a system information, in a RRCReleasemessage, or by inheriting from another RAT at inter-RAT cell (re) selection.

### New Radio (NR) Inter-Frequency and Inter-Radio Access Technology (RAT) Cell Reselection Criteria:

The UE performs cell selection/cell reselection based on the reception level and quality. Following are valid with respect to cell selection or cell reselection.

Srxlev=Qᵣₓₗₑᵥₘₑₐₛ−(Qᵣₓₗₑᵥₘᵢₙ+Q_{rxlevminoffset})−P_{compensation}−Qoffsetₜₑₘₚ; and Squal=Q_{qualmeas}−(Q_{qualmin}+Q_{qualminoffset})−Qoffsetₜₑₘₚ.

| | |
|---|---|
| Srxlev | Cell selection RX level value (dB) |
| Squal | Cell selection quality value (dB) |
| Qoffsetₜₑₘₚ | Offset temporarily applied to a cell as specified (dB) |
| Qᵣₓₗₑᵥₘₑₐₛ | Measured cell RX level value (RSRP) |
| Q_{qualmeas} | Measured cell quality value (RSRQ) |
| Qᵣₓₗₑᵥₘᵢₙ | Minimum required RX level in the cell (dBm). |
| Q_{qualmin} | Minimum required quality level in the cell (dB). |
| Q_{rxlevminoffset} | Offset to the signalled Qᵣₓₗₑᵥₘᵢₙ taken into account in the |
| | Srxlev evaluation as a result of a periodic search for a higher |
| | priority PLMN while camped normally in a VPLMN9]. |
| Q_{qualminoffset} | Offset to the signalled Q_{qualmin} taken into account in the Squal |
| | evaluation as a result of a periodic search for a higher priority |
| | PLMN while camped normally in a VPLMN |
| P_{compensation} | For FR1, if the UE supports the additionalPmax in the NR- |
| | NS-PmaxList, if present, in SIB1, SIB2 and SIB4: |
| | max(P_{EMAX1} − P_{PowerClass}, 0) − (min(P_{EMAX2}, P_{PowerClass}) − |
| | min(P_{EMAX1}, P_{PowerClass})) (dB); |
| | else: |
| | max(P_{EMAX1} − P_{PowerClass}, 0) (dB) |
| | For FR2, P_{compensation} is set to 0. |
| | For IAB-MT, P_{compensation} is set to 0. |
| P_{EMAX1}, P_{EMAX2} | Maximum TX power levels of a UE may use when |
| | transmitting on the uplink in the cell (dBm) defined as |
| P_{PowerClass} | Maximum RF output power of the UE (dBm) according to |
| | the UE power class |

If threshServingLowQ is broadcasted in system information and more than 1 second has elapsed since the UE camped on the current serving cell, the cell reselection to a cell on a higher priority NR frequency or inter-RAT frequency than the serving frequency shall be performed when:

a. A cell of a higher priority NR or Evolved Universal Terrestrial Radio Access Network (EUTRAN) radio access technology (RAT)/frequency fulfils Squal>the threshold Thresh_{X, HighQ} during a time interval Treselection_{RAT} (The TreselectionRAT is the cell reselection timer for the RAT broadcasted by the gNB and possibly scaled according to mobility)

Otherwise, the cell reselection to a cell on the higher priority NR frequency or the inter-RAT frequency than the serving frequency shall be performed when:
a. The cell of a higher priority RAT/frequency fulfils Srxlev>Thresh_{X, HighP} during a time interval Treselection_{RAT}; and
b. More than 1 second has elapsed since the UE camped on the current serving cell.

The cell reselection to the cell on an equal priority NR frequency shall be based on ranking for intra-frequency cell reselection as defined in clause 5.2.4.6. If threshServingLowQ is broadcast in system information and more than 1 second has elapsed since the UE camped on the current serving cell, the cell reselection to a cell on a lower priority NR frequency or inter-RAT frequency than the serving frequency shall be performed when:
a. The serving cell fulfils Squal<Thresh_{Serving, LowQ} and a cell of a lower priority NR or E-UTRAN RAT/frequency fulfils Squal>Thresh_{X, LowQ} during a time interval TreselectionRAT.

Otherwise, the cell reselection to the cell on a lower priority NR frequency or the inter-RAT frequency than the serving frequency shall be performed when:
a. The serving cell fulfils Srxlev<Thresh_{Serving, LowP} and a cell of a lower priority RAT/frequency fulfils Srxlev>Thresh_{X, LowP} during a time interval TreselectionRAT; and
b. More than 1 second has elapsed since the UE camped on the current serving cell.

threshServingLowQ,ThreshX, HighQ,ThreshX, HighP,ThreshServing, LowQ ThreshServing, LowP etc. are the thresholds provided by the RAN, normally in broadcast signalling.

Intra-frequency and equal priority inter-frequency Cell Reselection criteria: The cell-ranking criterion Rs for serving cell and Rn for neighbouring cells is defined by:

Rₛ=Q_{meas,s}+Q_{hyst}−Qoffsetₜₑₘₚ

Rₙ=Q_{meas,n}−Qoffset−Qoffsetₜₑₘₚ
Where:

| | |
|---|---|
| Qₘₑₐₛ | RSRP measurement quantity used in cell |
| | reselections. |
| Qoffset | For intra-frequency: Equals to Qoffset_{s, n}, if |
| | Qoffset_{s, n} is valid, otherwise this equals to |
| | zero. For inter-frequency: Equals to |
| | Qoffset_{s, n}plusQoffset_{frequency}, if Qoffset_{s, n} is |
| | valid, otherwise this equals to Qoffset_{frequency}. |
| Qoffsetₜₑₘₚ | Offset temporarily applied to a cell as specified |
| | in TS 38.331. |

The UE shall perform ranking of all cells that fulfil the cell selection criterion S, which is defined in 5.2.3.2. The cells shall be ranked according to the R criteria specified above by deriving Qmeas,n and Qmeas,s and calculating the R values using averaged RSRP results.

Non Terrestrial Networks (NTN)-5G NR supports non terrestrial networks. The 3GPP release 17 defines the NTN as given in the below extracts from TS 38.300. The NTN provides non-terrestrial NR access to the UE by means of an NTN payload and an NTN Gateway. The NTN payload transparently forwards the radio protocol received from the UE (via the service link) to the NTN Gateway (via the feeder link) and vice-versa. The following connectivity is supported by the NTN payload:
a. A gNB may serve multiple NTN payloads;
b. An NTN payload may be served by multiple gNBs.

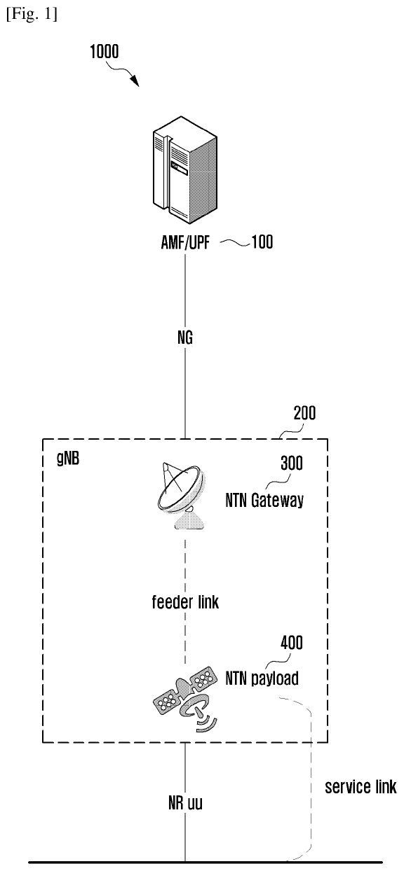

FIG. 1 illustrates the NTN (1000). The NTN (1000) includes a AMF device/UPF device (100), a network apparatus (e.g., gNB or the like) (200), a NTN gateway (300), and a NTN payload (400). FIG. 1 is explained in the context of the 3GPP TS 38.300.

The NTN (1000) provides a non-terrestrial new radio (NR) access to the UE by means of an NTN payload (400) and an NTN gateway (300), depicting a service link between the NTN payload (400) and the UE, and a feeder link between the NTN gateway (300) and the NTN payload (400).

A feeder link switchover is a procedure where the feeder link is changed from a source NTN. The NTN gateway to a target NTN gateway is provided for a specific NTN payload. The feeder link switchover is a transport network layer procedure. The service link switch refers to a change of the serving satellite. Both a hard feeder link switchover and a soft feeder link switchover are supported in the NTN (1000).

The feeder link switch over may result in transferring the established connection for the affected UEs between two gNBs. For the soft feeder link switch over, the NTN payload (400) is able to connect to more than one NTN Gateway (300) during a given period. That is, a temporary overlap can be ensured during the transition between the feeder links. For the hard feeder link switch over, the NTN payload (400) connects to only one NTN gateway (300) at any given time i.e. a radio link interruption may occur during the transition between the feeder links.

Further, a Non-Geosynchronous orbit (NGSO) includes Low Earth Orbit at altitude approximately between 300 km and 1500 km and Medium Earth Orbit at altitude approximately between 7000 km and 25000 km. Three types of service links are supported:
a. Earth-fixed: provisioned by beam(s) continuously covering the same geographical areas all the time (e.g., the case of GSO satellites);
b. Quasi-Earth-fixed: provisioned by beam(s) covering one geographic area for a limited period and a different geographic area during another period (e.g., the case of NGSO satellites generating steerable beams); and
c. Earth-moving: provisioned by beam(s) whose coverage area slides over the Earth surface (e.g., the case of NGSO satellites generating fixed or non-steerable beams).

With the NGSO satellites, the gNB (or the network apparatus (200)) can provide either quasi-Earth-fixed cell coverage or Earth-moving cell coverage, while the gNB operating with GSO satellite can provide Earth fixed cell coverage.

The 3GPP has introduced the support of distance and timing based cell reselection for NTN access. In an example, an idle mode specification TS 38.304 defines the below behaviour. Following rules are used by the UE to limit needed measurements:
a. If the serving cell fulfils Srxlev>S_{IntraSearchP} (S_{IntraSearchP} specifies the Srxlev threshold (in dB) for intra-frequency measurements and is provided in system information by the network usually) and Squal>S_{IntraSearchQ} (S_{IntraSearchQ} specifies the Squal threshold (in dB) for intra-frequency measurements.);
b. If distanceThresh is broadcasted in a SIB19, and if the UE supports location-based measurement initiation and has obtained its location information;
c. If the distance between the UE and the serving cell reference location is shorter than distanceThresh, the UE may not perform intra-frequency measurements;
d. Otherwise, the UE shall perform intra-frequency measurements;
e. Otherwise, the UE may not perform intra-frequency measurements;
f. Otherwise, the UE shall perform intra-frequency measurements;
g. The UE shall apply the following rules for NR inter-frequencies and inter-RAT frequencies which are indicated in system information and for which the UE has priority provided as defined in 5.2.4.1;
h. For a NR inter-frequency or inter-RAT frequency with a reselection priority higher than the reselection priority of the current NR frequency, the UE shall perform measurements of higher priority NR inter-frequency or inter-RAT frequencies according to TS 38.133.
i. For a NR inter-frequency with an equal or lower reselection priority than the reselection priority of the current NR frequency and for inter-RAT frequency with lower reselection priority than the reselection priority of the current NR frequency:
j. If the serving cell fulfils Srxlev>S_{nonIntraSearchP} (S_{nonIntraSearchP} specifies the Srxlev threshold (in dB) for NR inter-frequency and inter-RAT measurements.), and Squal>S_{nonIntraSearchQ} (S_{nonIntraSearchQ} specifies the Squal threshold (in dB) for NR inter-frequency and inter-RAT measurements):
k. If distanceThresh is broadcasted in SIB19, and if the UE supports location-based measurement initiation and has valid UE location information;
l. If the distance between UE and the serving cell reference location is shorter than distanceThresh, the UE may choose not to perform measurements of NR inter-frequency cells of equal or lower priority, or inter-RAT frequency cells of lower priority;
m. Otherwise, the UE shall perform measurements of NR inter-frequency cells of equal or lower priority, or inter-RAT frequency cells of lower priority according to TS 38.133;
n. Otherwise, the UE may choose not to perform measurements of NR inter-frequency cells of equal or lower priority, or inter-RAT frequency cells of lower priority;
o. Otherwise, the UE shall perform measurements of NR inter-frequency cells of equal or lower priority, or inter-RAT frequency cells of lower priority according to TS 38.133; and
p. If the UE supports relaxed measurement and relaxedMeasurement is present in SIB2, the UE may further relax the needed measurements, as specified in clause 5.2.4.9.

If the t-Service of the serving cell is present in SIB19, the UE shall perform intra-frequency, inter-frequency or inter-RAT measurements before the t-Service, regardless of the distance between UE and the serving cell reference location or whether the serving cell fulfils Srxlev>SIntraSearchP and Squal>SIntraSearchQ, or Srxlev>SnonIntraSearchP and Squal>SnonIntraSearchQ and the exact time to start measurement before t-Service is up to UE implementation. The UE shall perform measurements of higher priority NR inter-frequency or inter-RAT frequencies according to TS 38.133 regardless of the remaining service time of the serving cell (i.e. time remaining until t-Service).

When evaluating the distance between the UE and the serving cell reference location, it's up to the UE implementation to obtain UE location information.

The t-Service indicates the time information on when the cell provided via NTN quasi-Earth fixed system is going to stop serving the area the cell is currently covering. The field indicates a time in multiples of 10 ms after 00:00:00 on Gregorian calendar date 1 Jan. 1900 (midnight between Sunday, Dec. 31, 1899 and Monday, Jan. 1, 1900). The field is excluded when determining changes in system information, i.e. changes of t-Service should neither result in system information change notifications nor in a modification of valueTag in SIB1. The exact stop time is between the time indicated by the value of the field minus 1 and the time indicated by the value of this field.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Accordingly the embodiment herein is to provide a method for handling a cell selection and cell reselection in a NTN. The method includes receiving, by a UE, a service time, a t-service for a serving cell and a cell reselection timer for a neighbouring frequency broadcasted by a network apparatus. Further, method includes triggering to perform a cell reselection measurement at least a duration of the cell reselection timer before the t-service for the neighbouring frequency or at least before an absolute value of a t-service-applicable cell reselection timer irrespective of a predefined criteria. Alternatively, the method includes performing a cell reselection measurement at least for an applicable cell reselection timer duration before stopping the t-service.

The method can be used to handle the interaction of the service time, the t-service of quasi-earth fixed cells and the earth-moving cells with the cell reselection timer in the NTN, so as to handle the cell selection and the cell reselection in the NTN without wasting the resource and time effective manner. The method can also be used to handle the feeder link switch in the NTN.

Referring now to the drawings, and more particularly to FIGS. 1 through 8, there are shown preferred embodiments.

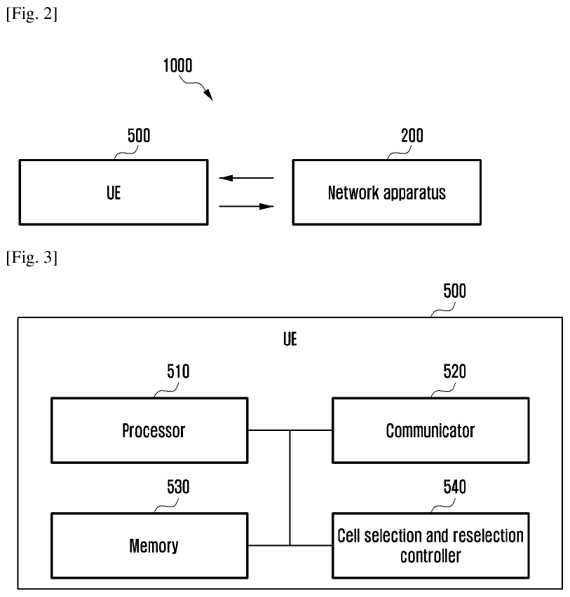

FIG. 2 illustrates a NTN (1000) for handling a cell selection and cell reselection, according to the embodiments as disclosed herein. The NTN includes a UE (500) and a network apparatus (200). The UE (500) can be, for example, but not limited to a laptop, a smart phone, a desktop computer, a notebook, a Device-to-Device (D2D) device, a vehicle to everything (V2X) device, a foldable phone, a smart TV, a tablet, an immersive device, and an internet of things (IoT) device. The network apparatus (200) can be, for example, but not limited to a gNB, a eNB, and a new radio (NR) trans-receiver.

In an embodiment, when the UE (500) receives a service time, a t-service for a serving cell and a cell reselection timer (i.e., Treselection) for a neighboring frequency or RAT broadcasted by the network apparatus (200), the UE (500) starts to perform cell reselection measurements at least before the t-service-applicable value of Treselection for the neighboring frequency or the RAT, irrespective of the distance between the UE (500) and a serving cell reference location or Srxlev is greater than SIntraSearchP and Squal is greater than SIntraSearchQ, or Srxlev is greater than SnonIntraSearchP and Squal is greater than SnonIntraSearchQ. Further, the UE (500) performs cell reselection measurements at least for applicable Treselection duration before the t-service.

In an embodiment, the UE (500) starts to perform cell reselection measurements at least before absolute value of tservice-applicable Treselection irrespective of other criteria such as the distance between the UE (500) and the serving cell reference location or Srxlev is greater than SIntraSearchP and Squal is greater than SIntraSearchQ, or Srxlev is greater than SnonIntraSearchP and Squal is greater than SnonIntraSearchQ.

In an embodiment, the applicable value of the Treselection in the embodiment is the Treselection value broadcasted in the system information for the frequency or RAT. In another embodiment, when a mobility based scaling is applied for Treselection, Treselection is the scaled Treselection value for the frequency.

The above embodiment may lead to the below changes in TS 38.304—

If the t-Service of the serving cell is present in SIB19, the UE shall
perform intra-frequency, inter-frequency or inter-RAT measurements before the t-
Service, regardless of the distance between UE and the serving cell reference
location or whether the serving cell fulfils Srxlev > SIntraSearchP and
Squal > SIntraSearchQ, or Srxlev > SnonIntraSearchP and Squal > SnonIntraSearchQ
and the exact time to start measurement before t-Service is up to UE
implementation, but UE needs to consider the applicable T-reselection for the
frequency or RAT while deciding the time to start measurements.
The UE shall perform measurements of higher priority NR inter-frequency
or inter-RAT frequencies according to TS 38.133 regardless of the remaining
service time of the serving cell (i.e. time remaining until t-Service).
NOTE:
When evaluating the distance between the UE and the serving cell reference location, it's up to the UE implementation to obtain the UE location information.

In an embodiment, when the t-Service and the Treselection are broadcasted, the network apparatus (200) broadcasts the Treselection to zero (or doesn't broadcast Treselection) for the neighbour frequencies and RATs.

In an embodiment, when the t-service and the Treselection are broadcasted, for all the neighbor frequencies and neighbour RATs, the network apparatus (200) broadcasts the Treselection to a value less than the duration to stop for t-service.

In an embodiment, the UE (500) ignores applicable cell reselection timer Treselection when the t-Service is provided (i.e., the UE (500) considers Treselection to zero).

In an embodiment, the UE (500) determines the applicable cell reselection timer Treselection to the duration to stop for t-Service, when the t-Service is provided.

In an embodiment, the UE (500) determines the applicable cell reselection timer Treselection to the value less than the duration to stop for the t-Service, when the t-Service is provided.

In an embodiment, the UE (500) ignores applicable cell reselection timer when the t-Service is provided and the duration to stop for t-Service≥applicable cell reselection timer Treselection.

In an embodiment, the UE sets applicable cell reselection timer Treselection to the duration to stop for t-Service or a value less than the duration to stop for t-service when the duration to stop fort-Service Preselection.

In an embodiment, the UE (500) ignores the applicable cell reselection timer when the t-Service is provided and the duration to stop for t-Service<applicable cell reselection timer Treselection.

In an embodiment, the UE (500) sets the applicable cell reselection timer Treselection to duration to stop t-Service or to a value lesser than the duration to stop for t-service when t-Service<Treselection.

In an embodiment, the Treselection value is applied for the embodiment, in deciding the time to measure the neighbour frequencies and RATs.

In an embodiment if Treselection is greater than the duration to stop for t-service, the UE (500) starts to measure the neighbour frequencies and RATs before the t-service, and measures the neighbour frequencies and RATs for a period of duration to stop for the t-service.

In an embodiment, the embodiments in aspects above are applied when the neighbour cell measurements are started at a time when Treselection is greater than the duration to stop for t-Service.

In an embodiment, for an earth moving cell, the UE (500) computes the duration to stop for t-Service based on the location, distance and relative velocity of the serving cell and uses the calculated duration to stop for t-Service rather than a broadcasted value for all the above embodiments.

In an embodiment, the network apparatus (200) broadcasts a t-service-feederswitch in the system information for triggering the UE (500) neighbor cell measurements for a feeder link switch. In an embodiment, the UE (500) performs the neighbor cell measurements before t-service-feederswitch.

In an embodiment, the t-service-feederswitch may be same as t-service such as t-service-r17.

In an embodiment, at the time t-service-feederswitch, the network apparatus (200) (i.e. cell) stops broadcasting the SSB. The network apparatus (200) also may stop providing all other services such as data transfer. Upon completing feeder switch, the network apparatus (200) broadcasts the SSB and may also provide other services.

In an embodiment, a delay tolerant UE service may skip performing neighbor cell measurements before t-service-feederswitch and may remain camped on the same cell.

In an embodiment, the UE (500) (e.g., delay tolerant UE or the like), which supports only MO (Mobile Originated calls), may skip performing neighbor cell measurements before the t-service-feederswitch and may remain camped on the same cell.

In an embodiment, the UE (500), which can tolerate service disruption for a short duration, may skip performing neighbor cell measurements before tservice-feederswitch and may remain camped on the same cell.

In an embodiment, the t-service-feederswitch is broadcasted when the feeder switch is a hard feeder switch and is not broadcasted if the feeder switch is a soft feeder switch.

In an embodiment, the UE (500) reselects back to the same NTN cell or selects the same NTN cell from which the UE (500) has moved due to feeder link switch when the cell reselection criteria is satisfied after the feeder link switch is completed.

In an embodiment, if the UE (500) is not able to find any neighbor cells before the feeder switch, the UE (500) moves to no service. The UE (500) searches for the frequency of the cell whose service was unable due to feeder switch after a certain duration. If the UE (500) is unable to select the cell, the UE (500) performs the search in certain intervals. That is, the UE (500) repeats searching for the frequency in certain intervals. The certain intervals are determined by the UE (500) or the network apparatus (200).

In an embodiment, if the UE (500) has moved to or camped on any cell state as the UE (500) was not able to find the suitable cell after the cell has become unavailable/unsuitable due to the feeder switch (i.e., at t-service-feeder switch) searches for the same cell (i.e. same frequency). If the UE (500) is unable to select the cell, the UE (500) performs the search for the same cell (i.e. same frequency) in the certain interval.

In an embodiment, the interval is different from the interval for other frequencies.

In an embodiment, the interval is different from the interval used for the same frequency when there is no cell which has become unavailable due to feeder switch. In short, the UE (500) utilizes the information that the service disruption is due to a feeder switch and that the disruption is for a short timer, and moves back to the same cell quickly.

In an embodiment, if the UE (500) has moved to any cell selection state as the UE (500) was not able to find the suitable cell after the cell has become unavailable due to the feeder switch (i.e., at t-service-feeder switch) may search for the same cell (i.e. same frequency). If the UE (500) is unable to select the cell, the UE (500) performs the search for the same cell (i.e. same frequency) in the certain interval.

In an embodiment, the interval is different from the interval for other frequencies.

In an embodiment, the interval is different from the interval used for the same frequency when there is no cell which has become unavailable due to feeder switch.

In an embodiment, the UE (500) in camped on any cell state or is in any cell selection state or no service state uses different criteria for searching for the cell or the frequency in the cell which has become unavailable/unsuitable due to the feeder switch (i.e., at t-service-feederswitch). That is, the UE (100) which is out of service or in limited service may search for the same frequency as the previous frequency or the same cell as the previous frequency.

In an embodiment, the network apparatus (200) (i.e. cell) broadcasts the timer which indicates the time the UE (500) is expected to come back to service after the tservice-feederswitch. The UE (500) in any cell selection or any cell or no service searches for the cell at/after the time. The UE (500) shall consider the cell as candidate for cell reselection only after the time.

In an embodiment, the network apparatus (200) broadcasts a timer which indicates the duration the UE (500) is expected to remain out of service after the tservice-feederswitch. The UE (500) in any cell selection or any cell or no service may search for the cell after the duration. The UE (500) considers the cell as candidate for cell reselection only after the duration from the t-service-feederswitch.

All the UE (500) and the network apparatus (200) embodiments related to tservice-feederswitch are applicable when the t-service is used for indicating the tservice-feederswitch.

FIG. 3 shows various hardware components of the UE (500), according to the embodiments as disclosed herein.

In an embodiment, the UE (500) includes a processor (510), a communicator (520), a memory (530) and a cell selection and reselection controller (540). The processor (510) is coupled with the communicator (520), the memory (530) and the cell selection and reselection controller (540).

The cell selection and reselection controller (540) receives the service time, the t-service for the serving cell and the cell reselection timer for the neighbouring frequency broadcasted by a network apparatus (200). The t-Service indicates the time information on when the cell provided via the network apparatus (200) is going to stop serving the area in which the cell is currently covering the service. The cell reselection timer indicates the time interval during which the cell reselection criteria remains fulfilled for the UE (500) to perform the cell reselection. The cell reselection timer is broadcasted in the system information for the frequency or the RAT.

The t-service includes the t-service-feeder switch, the time the cell stops service due to the t-service-feeder switch and the UE (500) performs the measurements before the t-service-feeder switch irrespective of the cell reselection timer and performs measurement considering the applicable cell reselection timer along with the t-service. In NR, the applicable cell reselection timer is the Treselection value broadcasted by the network apparatus (200). For example, if the cell reselection timer is 8 seconds and the t-service indicates 5 PM on a specific date, the UE (100) may perform the measurements at least 8 seconds before 5 PM. The Treselection may be subject to scaling due to mobility. For example, if the scaling factor is 2 and the cell reselection timer is 8 seconds, applicable cell reselection timer is 16 seconds. Similarly if the scaling factor is half (½) and the cell reselection timer is 8 seconds, applicable cell reselection timer is 4 seconds.

In an embodiment, the cell selection and reselection controller (540) triggers to perform the cell reselection measurement at least the duration of the cell reselection timer before the t-service for the neighbouring frequency or at least before the absolute value of the t-service-applicable cell reselection timer irrespective of the predefined criteria. If the cell reselection timer is 8 seconds and the t-service indicates 5 PM on a specific date and the present time is 4 seconds before 5 PM, the UE (500) may perform measurements 4 seconds before 5 PM, i.e. 4 seconds before present time. When the t-service is given as the time remaining for service and is given as 4 seconds and the cell reselection timer is 8 seconds, absolute value of t-service-applicable cell reselection timer is 4 seconds. If the t-service is larger than the applicable cell reselection timer, absolute value is same as t-service-applicable cell reselection timer. The predefined criteria can be, for example, but not limited to the distance between the UE (500) and the reference location of the serving cell, the Srxlev greater than the SIntraSearchP, the Squal greater than the SIntraSearchQ, the Srxlev greater than the SnonIntraSearchP and the Squal greater than the SnonIntraSearchQ. The Srxlev indicates the cell selection RX level value (dB). The Squal indicates the cell selection quality value (dB).

In another embodiment, the cell selection and reselection controller (540) performs the cell reselection measurement at least for the applicable cell reselection timer duration before stopping the t-service.

In an embodiment, the cell selection and reselection controller (540) determines that the cell reselection criteria is satisfied after the feeder link switch is completed. Further, the cell selection and reselection controller (540) reselects back to the same serving cell from which the UE (500) has moved due to the feeder link switch.

In an embodiment, the cell selection and reselection controller (540) determines that the UE (500) has moved to camped on any cell state upon determining that the UE (500) is not able to find the suitable cell after the cell has become unavailable due to the feeder switch or to the no service area after the cell has become unavailable due to a feeder switch. Further, the cell selection and reselection controller (540) performs the search in the predefined interval to select the cell.

In an embodiment, the cell selection and reselection controller (540) receives the timer information broadcasted by the network apparatus (200). The timer information indicating the time in which the UE (500) is expected to come back to the service after the t-service. Further, the cell selection and reselection controller (540) determines the cell as candidate for the cell reselection after the time when the UE (500) is in any cell selection state or any cell state or no service state.

Further, the cell selection and reselection controller (540) ignores applicable cell reselection timer or determines the applicable cell reselection timer to the duration to stop for the t-service, or determines the applicable cell reselection timer to the value less than the duration to stop for the t-service, when the t-service is provided and the duration to stop for the t-Service is less than cell reselection timer.

The cell selection and reselection controller (540) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (510) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (510) may include multiple cores and is configured to execute the instructions stored in the memory (530).

Further, the processor (510) is configured to execute instructions stored in the memory (530) and to perform various processes. The communicator (520) is configured for communicating internally between internal hardware components and with external devices via one or more networks. The memory (530) also stores instructions to be executed by the processor (510). The memory (530) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (530) may, in some examples, be considered a non-transitory storage medium. The term “non-transitory” may indicate that the storage medium is not embodied in a carrier wave or a propagated signal. However, the term “non-transitory” should not be interpreted that the memory (530) is non-movable. In certain examples, a non-transitory storage medium may store data that can, over time, change (e.g., in Random Access Memory (RAM) or cache).

Although the FIG. 3 shows various hardware components of the UE (500) but it is to be understood that other embodiments are not limited thereon. In other embodiments, the UE (500) may include less or more number of components. Further, the labels or names of the components are used only for illustrative purpose and does not limit the scope of the invention. One or more components can be combined together to perform same or substantially similar function in the UE (500).

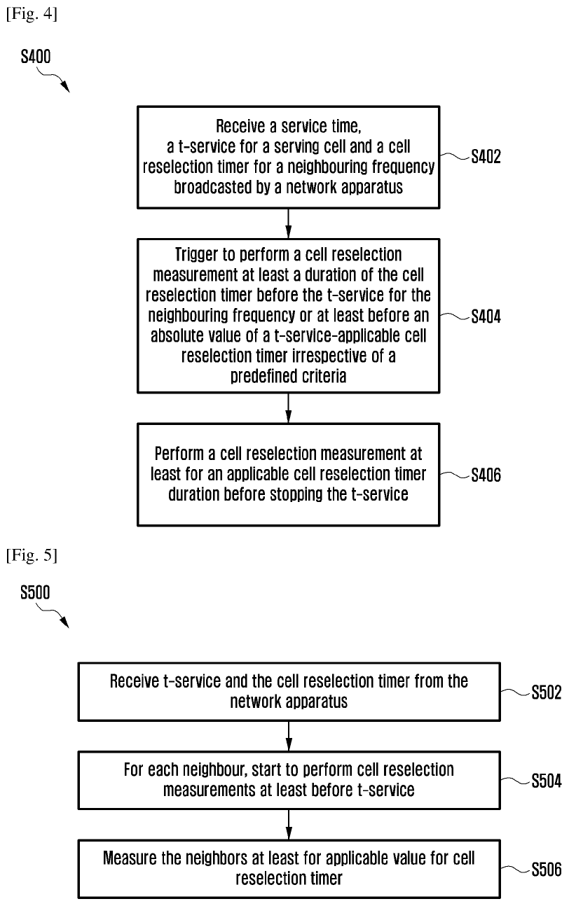

FIG. 4 is a flow chart (S400) illustrating a method for handling the cell selection and cell reselection in the NTN (1000), according to the embodiments as disclosed herein. The operations (S402-S406) are handled by the cell selection and reselection controller (540).

At step S402, the method includes receiving the service time, the t-service for the serving cell and the cell reselection timer for the neighbouring frequency broadcasted by the network apparatus (200).

At step S404, the method includes triggering to perform the cell reselection measurement at least the duration of the cell reselection timer before the t-service for the neighbouring frequency or at least before the absolute value of the t-service-applicable cell reselection timer irrespective of the predefined criteria.

At step S406, the method includes performing the cell reselection measurement at least for the applicable cell reselection timer duration before stopping the t-service.

FIG. 5 is a flow chart (S500) illustrating a scenario of a method for handling of the T-service and the Treselection at the UE (500), according to the embodiments as disclosed herein. The operations (S502-S506) are handled by the cell selection and reselection controller (540).

At step S502, the method includes receiving the t-service and the cell reselection timer from the network apparatus (200).

At step S504, the method includes starting to perform the cell reselection measurements at least before the t-service for each neighbour.

At step S506, the method includes measuring the neighbors at least for applicable value for the cell reselection timer.

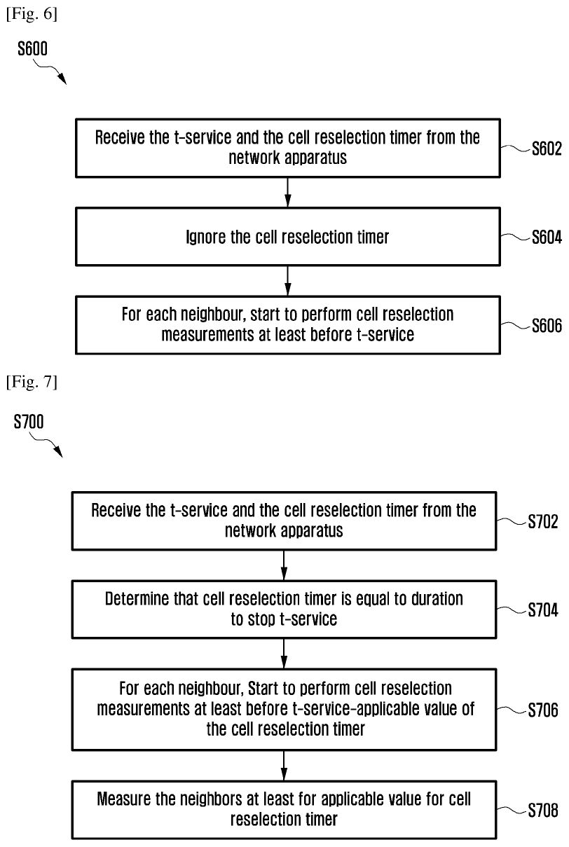

FIG. 6 is another flow chart (S600) illustrating a scenario of a method for handling of Tservice and Treselection at the UE (500), according to the embodiments as disclosed herein. The operations (S602-S614) are handled by the cell selection and reselection controller (540).

At step S602, the method includes receiving the t-service and the cell reselection timer from the network apparatus (200).

At step S604, the method includes ignoring the cell reselection timer.

At step S606, the method includes starting to perform cell reselection measurements at least before t-service for each neighbour.

FIG. 7 is another flow chart (S700) illustrating a scenario of a method for handling of Tservice and Treselection at the UE (500), according to the embodiments as disclosed herein. The operations (S702-S708) are handled by the cell selection and reselection controller (540).

At step S702, the method includes receiving the t-service and the cell reselection timer from the network apparatus (200).

At step S704, the method includes determining that the cell reselection timer is equal to duration to stop t-service. At step S706, the method includes starting to perform cell reselection measurements at least before the t-service-applicable value of the cell reselection timer for each neighbour.

At step S706, the method includes measuring the neighbors at least for applicable value for the cell reselection timer.

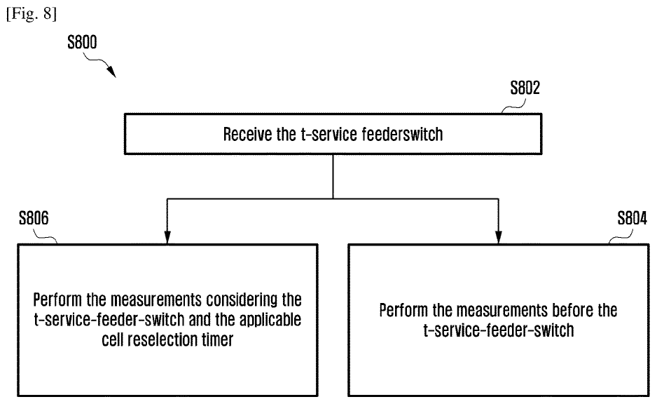

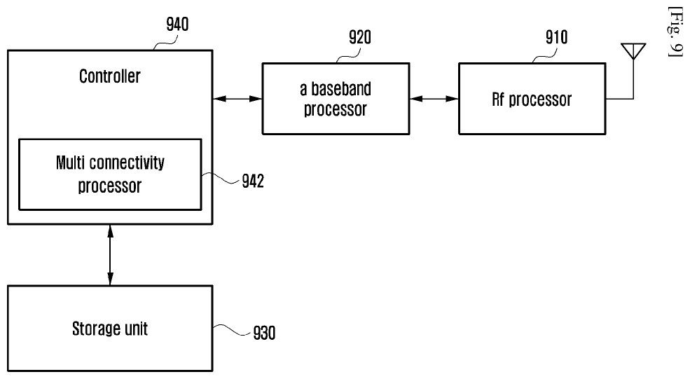

FIG. 8 is another flow chart (S800) illustrating a scenario of a method for handling of t-service-feederswitch at the UE (500), according to the embodiments as disclosed herein.

The operations (S802-S806) are handled by the cell selection and reselection controller (540).

At step S802, the method includes receiving the t-service-feederswitch.

At step S804, the method includes performing the measurements before the tservice-feeder-switch.

At step S806, the method includes performing the measurements considering the tservice-feeder-switch and the applicable cell reselection timer.

The method can be used to handle the interaction of the service time, the t-service of quasi-earth fixed cells and the earth-moving cells with the cell reselection timer in the NTN, so as to handle the cell selection and the cell reselection in the NTN without wasting the resource and time effective manner. The method can also be used to handle the feeder link switch in the NTN.

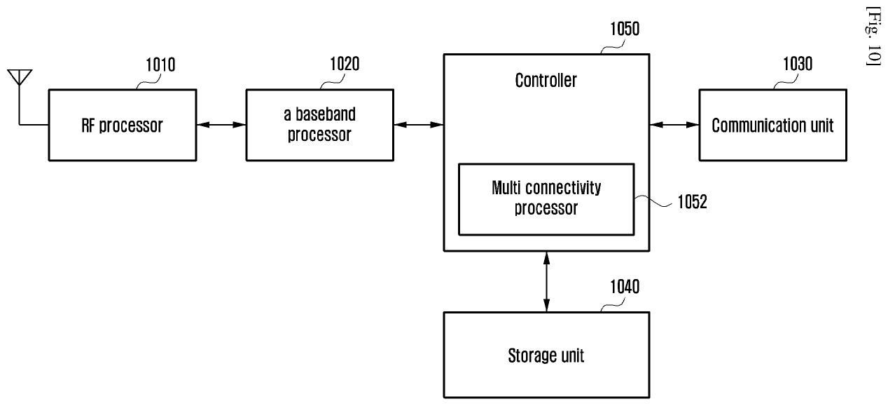

FIG. 9 illustrates the structure of the UE to which embodiments of the disclosure can be applied.

The structure of the UE to which embodiments of the disclosure can be applied is illustrated in FIG. 9.

Referring to FIG. 9, the UE includes a radio frequency (RF) processor 910, a baseband processor 920, a storage unit 930, and a controller 940.

The RF processor 910 performs a function for transmitting and receiving a signal through a wireless channel, such as band conversion and amplification of a signal. That is, the RF processor 910 up-converts a baseband signal provided from the baseband processor 920 into an RF band signal, transmits the RF band signal through an antenna, and then down-converts the RF band signal received through the antenna into a baseband signal. For example, the RF processor 910 may include a transmission filter, a reception filter, an amplifier, a mixer, an oscillator, a digital-to-analog converter (DAC), an analog-to-digital converter (ADC), and the like. Although FIG. 9 illustrates only one antenna, the UE may include a plurality of antennas. In addition, the RF processor 910 may include a plurality of RF chains. Moreover, the RF processor 910 may perform beamforming. For the beamforming, the RF processor 910 may control a phase and a size of each signal transmitted/received through a plurality of antennas or antenna elements. The RF processor may perform MIMO and receive a plurality of layers when performing the MIMO operation. The RF processor 910 may appropriately configure a plurality of antennas or antenna elements according to the control of the controller to perform reception beam sweeping or control a direction of a reception beam and a beam width so that the reception beam corresponds to a transmission beam.

The baseband processor 920 performs a function for a conversion between a baseband signal and a bitstream according to a physical layer standard of the system. For example, when data is transmitted, the baseband processor 920 generates complex symbols by encoding and modulating a transmission bitstream. Further, when data is received, the baseband processor 920 reconstructs a reception bitstream by demodulating and decoding a baseband signal provided from the RF processor 910. For example, in an orthogonal frequency division multiplexing (OFDM) scheme, when data is transmitted, the baseband processor 920 generates complex symbols by encoding and modulating a transmission bitstream, mapping the complex symbols to subcarriers, and then configures OFDM symbols through an inverse fast Fourier transform (IFFT) operation and a cyclic prefix (CP) insertion. Further, when data is received, the baseband processor 920 divides the baseband signal provided from the RF processor 910 in the unit of OFDM symbols, reconstructs the signals mapped to the subcarriers through a fast Fourier transform (FFT) operation, and then reconstructs a reception bitstream through demodulation and decoding.

The baseband processor 920 and the RF processor 910 transmit and receive signals as described above. Accordingly, the baseband processor 920 and the RF processor 910 may be referred to as a transmitter, a receiver, a transceiver, or a communication unit. Further, at least one of the baseband processor 920 and the RF processor 910 may include a plurality of communication modules to support a plurality of different radio access technologies. In addition, at least one of the baseband processor 920 and the RF processor 910 may include different communication modules to process signals of different frequency bands. For example, the different radio-access technologies may include an LTE network and an NR network. Further, the different frequency bands may include a super high frequency (SHF) (for example, 2.5 GHz and 5 Ghz) band and a millimeter (mm) wave (for example, 60 GHz) band.

The storage unit 930 stores data such as basic program, an application, and setting information for the operation of the UE. The storage unit 930 provides the stored data according to a request from the controller 940.

The controller 940 controls the overall operation of the UE. For example, the controller 940 transmits/receives a signal through the baseband processor 920 and the RF processor 910. In addition, the controller 940 may record data in the storage unit 930 and read the data. To this end, the controller 940 may include at least one processor. For example, the controller 940 may include a communication processor (CP) that performs a control for communication, and an application processor (AP) that controls a higher layer such as an application program.

FIG. 10 illustrates a block diagram of a base station in a wireless communication system to which embodiments of the disclosure can be applied.

As illustrated in FIG. 10, the base station includes an RF processor 1010, a baseband processor 1020, a backhaul communication unit 1030, a storage unit 1040, and a controller 1050.

The RF processor 1010 performs a function for transmitting and receiving a signal through a wireless channel, such as band conversion and amplification of a signal. That is, the RF processor 1010 up-converts a baseband signal provided from the baseband processing unit 1020 into an RF band signal and then transmits the converted signal through an antenna, and down-converts an RF band signal received through the antenna into a baseband signal. For example, the RF processor 1010 may include a transmission filter, a reception filter, an amplifier, a mixer, an oscillator, a DAC, and an ADC. Although FIG. 10 illustrates only one antenna, the first access node may include a plurality of antennas. In addition, the RF processor 1010 may include a plurality of RF chains. Moreover, the RF processor 1010 may perform beamforming. For the beamforming, the RF processor 1010 may control a phase and a size of each of the signals transmitted and received through a plurality of antennas or antenna elements. The RF processor may perform a downlink MIMO operation by transmitting one or more layers.

The baseband processor 1020 performs a function of performing conversion between a baseband signal and a bitstream according to a physical layer standard of the first radio access technology. For example, when data is transmitted, the baseband processor 1020 generates complex symbols by encoding and modulating a transmission bitstream. Further, when data is received, the baseband processor 1020 reconstructs a reception bitstream by demodulating and decoding a baseband signal provided from the RF processor 1010. For example, in an OFDM scheme, when data is transmitted, the baseband processor 1020 may generate complex symbols by encoding and modulating the transmission bitstream, map the complex symbols to subcarriers, and then configure OFDM symbols through an IFFT operation and CP insertion. In addition, when data is received, the baseband processor 1020 divides a baseband signal provided from the RF processor 1010 in units of OFDM symbols, recovers signals mapped with sub-carriers through an FFT operation, and then recovers a reception bitstream through demodulation and decoding. The baseband processor 1020 and the RF processor 1010 transmit and receive signals as described above. Accordingly, the baseband processor 1020 and the RF processor 1010 may be referred to as a transmitter, a receiver, a transceiver, or a communication unit.

The communication unit 1030 provides an interface for communicating with other nodes within the network.

The storage unit 1040 stores data such as a basic program, an application, and setting information for the operation of the MeNB. Particularly, the storage unit 1040 may store information on bearers allocated to the accessed UE and the measurement result reported from the accessed UE. Further, the storage unit 1040 may store information on a reference for determining whether to provide multiple connections to the UE or stop the multiple connections. In addition, the storage unit 1040 provides data stored therein according to a request from the controller 1050.

The controller 1050 controls the overall operation of the MeNB. For example, the controller 1050 transmits and receives a signal through the baseband processor 1020 and the RF processor 1010 or through the backhaul communication unit 1030. In addition, the controller 1050 may record data in the storage unit 1040 and read the data. To this end, the controller 1050 may include at least one processor.

Although the present disclosure has been described with various embodiments, various changes and modifications may be suggested to one skilled in the art. It is intended that the present disclosure encompass such changes and modifications as fall within the scope of the appended claims.

The various actions, acts, blocks, steps, or the like in the flow charts (S400-S800) may be performed in the order presented, in a different order or simultaneously. Further, in some embodiments, some of the actions, acts, blocks, steps, or the like may be omitted, added, modified, skipped, or the like without departing from the scope of the invention.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A method performed by a terminal supporting a cell reselection in a non-terrestrial network (NTN), the method comprising:
receiving, from a network apparatus, a t-service for a serving cell and a cell reselection timer for a neighbouring frequency;
triggering to perform a cell reselection measurement irrespective of a predefined criteria; and
based on the t-service and the cell reselection timer, performing the cell reselection measurement during an applicable cell reselection timer duration.

2. The method of claim 1,
wherein in case that the t-service indicates first time information on stopping a service, the applicable cell reselection timer duration is a duration during the cell reselection timer before the t-service,
wherein in case that the t-service indicates second time information on remaining time for the service and the second time information is equal or smaller than a cell reselection timer duration, the applicable cell reselection timer duration is same as the second time information, and
wherein in case that the t-service indicates second information on remaining time for the service and the second time information is larger than the cell reselection timer duration, the applicable cell reselection timer duration is same as a cell reselection timer duration.

3. The method of claim 1,
wherein the predefined criteria includes at least one of a distance between the terminal and a reference location of the serving cell, a first condition that a Srxlev is greater than a SIntraSearchP, a second condition that a Squal is greater than a SIntraSearchQ, a third condition that a Srxlev is greater than a SnonIntraSearchP, or fourth condition that a Squal is greater than a SnonIntraSearchQ,
wherein the t-service is time information on when the serving cell is to stop serving an area in which the serving cell is covering,
wherein the cell reselection timer indicates a time interval during which a cell reselection criteria remains fulfilled for the terminal to perform the cell reselection, and
wherein the cell reselection timer is broadcasted in system information for a frequency or a radio access technology (RAT).

4. The method of claim 1, the method further comprising:
in case that the t-service for the serving cell includes a t-service-feeder switch, performing measurements before the t-service-feeder switch, irrespective of the cell reselection timer,
wherein the t-service-feeder switch is time information associated with stopping a service due to a feeder switch.

5. The method of claim 1, the method further comprising:
in case that the t-service for the serving cell includes a t-service-feeder switch, performing measurements considering the t-service-feeder switch and the applicable cell reselection timer,
wherein the t-service-feeder switch is time information associated with stopping a service due to a feeder switch.

6. The method of claim 1, the method further comprising:
receiving, from the network apparatus, third timer information indicating an expected time for the terminal to come back to a service after the t-service; and
in case that the terminal is in at least one of any cell selection state, any cell state, or no service state after the expected time, considering a cell associated with the at least one of the any cell selection state, any cell state, or no service state as a candidate for the cell reselection.

7. A method performed by a base station supporting a cell reselection in a non-terrestrial network (NTN), the method comprising:
generating a t-service for a serving cell and a cell reselection timer for a neighbouring frequency; and
transmitting the t-service for the serving cell and the cell reselection timer for the neighbouring frequency;
wherein a cell reselection measurement is triggered to perform irrespective of a predefined criteria, and
wherein the cell reselection measurement is performed during an applicable cell reselection timer duration, based on the t-service and the cell reselection timer.

8. The method of claim 7,
wherein in case that the t-service indicates first time information on stopping a service, the applicable cell reselection timer duration is a duration during the cell reselection timer before the t-service,
wherein in case that the t-service indicates second time information on remaining time for the service and the second time information is equal or smaller than a cell reselection timer duration, the applicable cell reselection timer duration is same as the second time information, and
wherein in case that the t-service indicates second information on remaining time for the service and the second time information is larger than the cell reselection timer duration, the applicable cell reselection timer duration is same as a cell reselection timer duration.

9. A terminal supporting a cell reselection in a non-terrestrial network (NTN), the terminal comprising:
a transceiver; and
a controller configured to:
receive, from a network apparatus, a t-service for a serving cell and a cell reselection timer for a neighbouring frequency,
trigger to perform a cell reselection measurement irrespective of a predefined criteria, and
based on the t-service and the cell reselection timer, perform the cell reselection measurement during an applicable cell reselection timer duration.

10. The terminal of claim 9,
wherein in case that the t-service indicates first time information on stopping a service, the applicable cell reselection timer duration is a duration during the cell reselection timer before the t-service,
wherein in case that the t-service indicates second time information on remaining time for the service and the second time information is equal or smaller than a cell reselection timer duration, the applicable cell reselection timer duration is same as the second time information, and
wherein in case that the t-service indicates second information on remaining time for the service and the second time information is larger than the cell reselection timer duration, the applicable cell reselection timer duration is same as a cell reselection timer duration.

11. The terminal of claim 9,
wherein the predefined criteria includes at least one of a distance between the terminal and a reference location of the serving cell, a first condition that a Srxlev is greater than a SIntraSearchP, a second condition that a Squal is greater than a SIntraSearchQ, a third condition that a Srxlev is greater than a SnonIntraSearchP, or fourth condition that a Squal is greater than a SnonIntraSearchQ,
wherein the t-service is time information on when the serving cell is to stop serving an area in which the serving cell is covering,
wherein the cell reselection timer indicates a time interval during which a cell reselection criteria remains fulfilled for the terminal to perform the cell reselection, and
wherein the cell reselection timer is broadcasted in system information for a frequency or a radio access technology (RAT).

12. The terminal of claim 9, the controller is further configured to:
in case that the t-service for the serving cell includes a t-service-feeder switch, perform measurements before the t-service-feeder switch, irrespective of the cell reselection timer or perform measurements considering the t-service-feeder switch and the applicable cell reselection timer,
wherein the t-service-feeder switch is time information associated with stopping a service due to a feeder switch.

13. The terminal of claim 9, the controller is further configured to:
receive, from the network apparatus, third timer information indicating an expected time for the terminal to come back to a service after the t-service, and
in case that the terminal is in at least one of any cell selection state, any cell state, or no service state after the expected time, consider a cell associated with the at least one of the any cell selection state, any cell state, or no service state as a candidate for the cell reselection.

14. A base station supporting a cell reselection in a non-terrestrial network (NTN), the terminal comprising:
a transceiver; and
a controller configured to:
generate a t-service for a serving cell and a cell reselection timer for a neighbouring frequency, and
transmit the t-service for the serving cell and the cell reselection timer for the neighbouring frequency,
wherein a cell reselection measurement is triggered to perform irrespective of a predefined criteria, and
wherein the cell reselection measurement is performed during an applicable cell reselection timer duration, based on the t-service and the cell reselection timer.

15. The base station of claim 14,
wherein in case that the t-service indicates first time information on stopping a service, the applicable cell reselection timer duration is a duration during the cell reselection timer before the t-service,
wherein in case that the t-service indicates second time information on remaining time for the service and the second time information is equal or smaller than a cell reselection timer duration, the applicable cell reselection timer duration is same as the second time information, and
wherein in case that the t-service indicates second information on remaining time for the service and the second time information is larger than the cell reselection timer duration, the applicable cell reselection timer duration is same as a cell reselection timer duration.
